(19) United States
(12) Patent Application Publication
(10) Pub. No.: US 2012/0026087 A1
(43) Pub. Date: Feb. 2, 2012

(54) MOVABLE OPERATION PLATE MODULE AND ELECTRONIC DEVICE WITH THE SAME

(76) Inventor: Lian-Tien KE, Taipei (TW)

(21) Appl. No.: 13/191,938

(22) Filed: Jul. 27, 2011

(30) Foreign Application Priority Data
Jul. 28, 2010 (TW) 099124980

(51) Int. Cl. G09G 5/08; G08C 21/00

(52) U.S. Cl. 345/157; 178/18.03

(57) ABSTRACT

An electronic device with a moveable operation plate is provided. The electronic device includes a body, an operation plate and a sensing module. The body includes a disposing portion. The operation plate is moveably disposed on the body and electrically connected with the body. The sensing module is disposed on the body for sensing the movement of the operation plate to generate a moving signal, and the moving signal is transmitted to the body via the electrically connection and make the body execute a corresponding instruction.

### CROSS REFERENCE TO RELATED APPLICATIONS

This Non-provisional application claims priority under 35 U.S.C. §119(a) on Patent Application No(s). 099124980 filed in Taiwan, Republic of China on Jul. 28, 2010, the entire contents of which are hereby incorporated by reference.

### BACKGROUND OF THE INVENTION

1. Field of Invention

The invention relates to an electronic device and, more particularly, to an electronic device with a moveable operation plate.

2. Related Art

The mouse is importable and needs a moving space, and thus the notebook computer is always configured with a touch pad to input instructions conveniently. The touch pad is always electrically connected to the notebook computer, so the touch pad can be used directly without resetting after turning on the notebook computer, and the touch pad can control the movement of the cursor in a limited space, which can achieve the function the same as a mouse.

Most conventional input devices, such as the touch pads, the track pads, or the trackballs include cursor for moving and confirming functions, but the operations of clicking left or right mouse button should be achieved by disposing corresponding keys near the touch pad or combining input instructions via the multi-touch function. However, in the latter solution, users should be familiar with the input method of the multi-touch instructions in advance, which is not convenient and intuitive.

In sum, the input devices, such as the conventional touch pads, are not intuitive in operating.

### SUMMARY OF THE INVENTION

An electronic device with an operation plate is provided to provide user a more intuitive instruction input method by moving the moveable operation plate.

The embodiment discloses an electronic device with a moveable operation plate, which includes a body, an operation plate and a sensing module. The operation plate is moveably disposed at the body and electrically connected with the body. The sensing module is disposed at the body for sensing the movement of the operation plate to generate a moving signal, wherein the moving signal is transmitted to the body via an electrically connection between the operation plate and the body to make the body execute a corresponding instruction.

The embodiment also discloses an operation plate module, which includes an operation plate and a sensing module. The operation plate is moveably disposed at the body and electrically connected with the body. The sensing module is disposed at the body for sensing the movement of the operation plate to generate a moving signal. When the operation plate is disposed at the electronic device, the operation plate do not contact with the body, and the moving signal is transmitted to the body via an electrically connection between the operation plate and the body and make the body execute a corresponding instruction.

The operation plate in the embodiment can input instruction via vertical or horizontal moving, or axis rotating. Except for that, the operation plate can execute much more instructions via other motions without limitations of usage, and it can allow users controlling the electronic device more intuitively comparing with the prior arts.

### BRIEF DESCRIPTION OF THE DRAWINGS

FIG. 1 is a schematic diagram showing an electronic device in a first embodiment.

FIG. 2 is a cross-section diagram showing the electronic device in FIG. 1 viewed along a line A-A′.

FIG. 3A to FIG. 3D are schematic diagrams showing an operation plate operating in different modes in a first embodiment.

FIG. 4 is a schematic diagram showing an electronic device in a second embodiment.

FIG. 5 is a cross-section diagram showing the electronic device in FIG. 4 viewed along a line A-A′.

FIG. 6 is a schematic diagram showing another electronic device whose body includes a ladder-typed structure in a third embodiment.

FIG. 7 is a cross-section diagram showing the electronic device in FIG. 6 viewed along a line A-A′.

FIG. 8 is a schematic diagram showing an electronic device in a third embodiment.

FIG. 9 is a cross-section diagram showing the electronic device in FIG. 8 viewed along a line A-A′.

### DETAILED DESCRIPTION OF THE INVENTION

### The First Embodiment

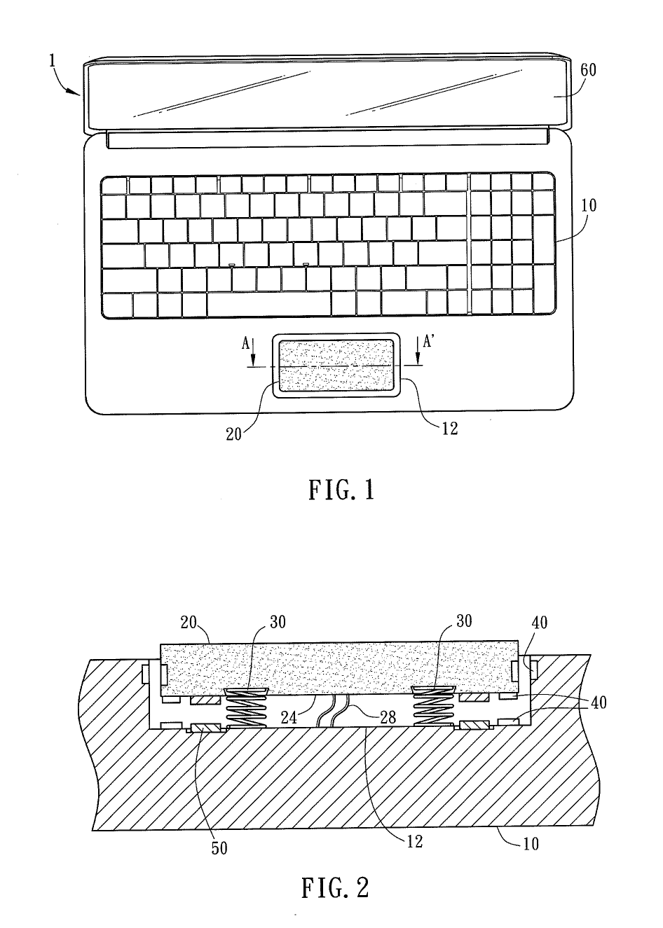

FIG. 1 is a schematic diagram showing the electronic device in a first embodiment. FIG. 2 is a cross-section diagram showing the electronic device in FIG. 1 viewed along a line A-A′.

In this embodiment, an electronic device I includes a display 60, a body 10, an operation plate 20, a support module 30, and a sensing module 40.

The display 60 may be coupled to the body 10. The body 10 includes corresponding components for processing information or instructions. For example, the body 10 includes a motherboard, a central processing unit (CPU), or other integrated circuits (IC), a register memory or a hard disk for storing information, interfaces for inputting instructions such as a keyboard, a touch pad, a trackball, and a writing pad, and interfaces such as kinds of connectors, a wired or wireless communication connecting module for communicating with other peripheral devices or systems.

In this embodiment, the electronic device 1 is a notebook computer, but it is not limited herein. The electronic device 1 also may be any other electronic devices with the operation plate 2 mentioned above, such as a handwriting pad or a mobile phone.

The body 10 includes an operation area, and the operation area is a disposing portion 12 in this embodiment. The operation plate 20 is moveably disposed in the disposing portion 12 and electrically connected with the body 10. The operation plate 20 may be a plate without the touch control function, just like the left key or the right key of the conventional mouse, which triggers a control unit to generate a touch signal when it is pressed by a user.

The operation plate 20 also may be a touch pad with the touch control function for generating a touch signal by sensing the touch thereon. The operation plate 20 also may be a touch pad with the display and touch control functions for displaying a message or generating a touch signal when it senses the touch operation of the user. The type of the operation plate 20 is not limited thereto.

The operation area can define the moving range of the operation plate 20. The height of the operation plate 20 in the electronic device is not limited, and the placement of the operation plate 20 may be different for convenience usage. In this embodiment, the disposing portion 12 can avoid that the operation plate 20 protrudes from the operation surface to interfere with the use of the other elements of the electronic device 1.

Moreover, the operation area of the body of the electronic device, which may be an opening or a concave portion, may be close to the keyboard of the notebook computer to allow the operation plate 20 to be disposed therein and connected with the body, and the operation plate 20 also would not protrude from the whole operation area.

In this embodiment, a support module 30 is disposed between the disposing portion 12 and the operation plate 20 to form a gap between the operation plate 20 and the body 10, and thus the operation plate 20 can be moved downward along the direction vertical to the operation plate 20. When a user presses the operation plate 20 to move vertically, a moving signal is output to the body 10 of the electronic device 1.

A sensing module 40 is disposed between the body 10 and the operation plate 20 for sensing the movement of the operation plate 20 to generate a moving signal, and the touch signal and the moving signal are transmitted to the body 10 via the electrical connection.

As described above, it allows the user to press the operation plate 20 to move downward. Additionally, the operation plate 20 also can generate certain moving signals according to the axial rotating movement and moving horizontally to input the corresponding instructions to the electronic device.

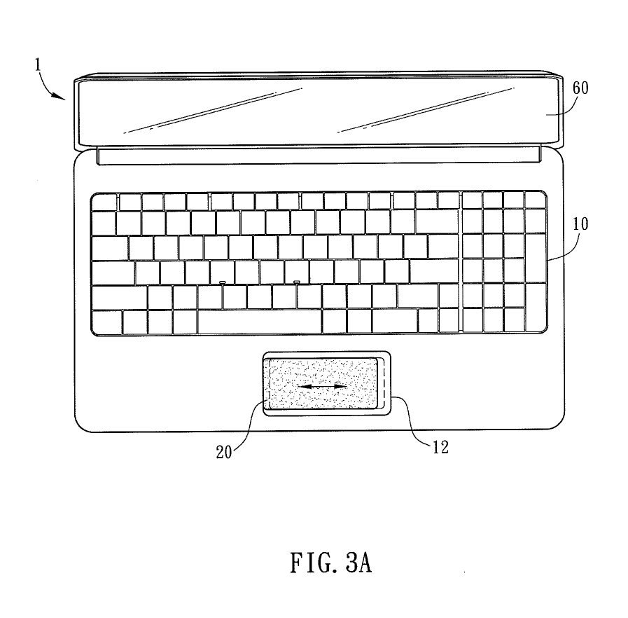

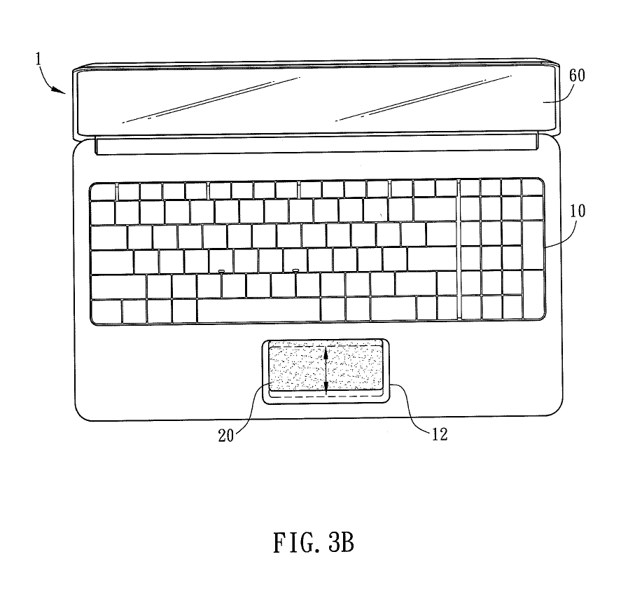

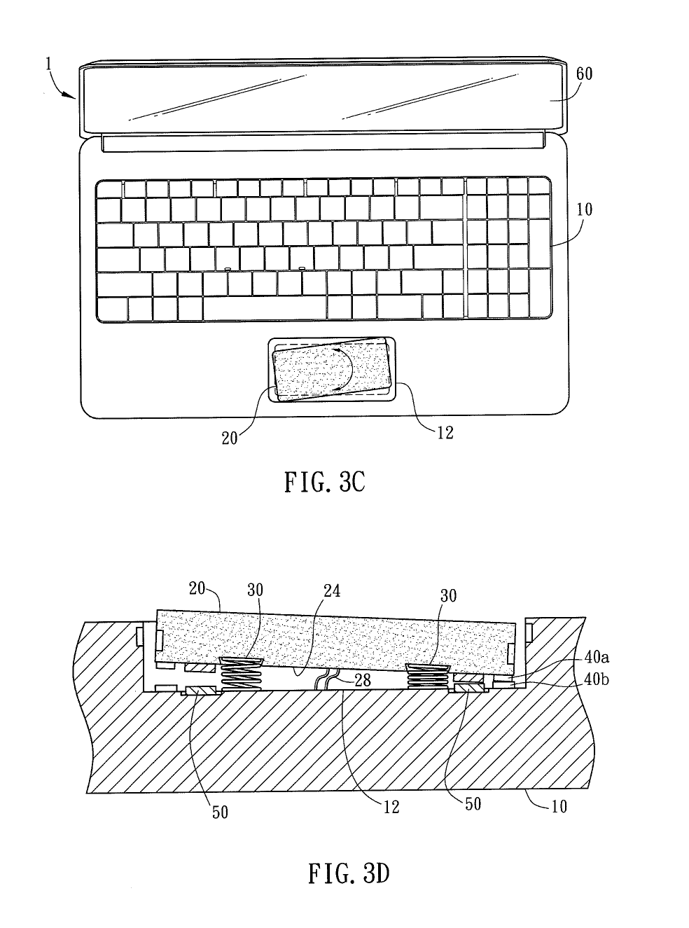

FIG. 3A to FIG. 3D are operating schematic diagrams showing the operation plate 20 operating in different modes in a first embodiment.

In this embodiment, if the operation plate 20 is horizontally moved (as showed in FIG. 3A or FIG. 3B), instructions are generated to move contents or images displayed by the electronic device 1, and the direction and distance of the movement is determined by the direction and the duration of the horizontal movement of the operation plate 20, respectively. At the time, the images displayed can be scrolled up or down, or the picture can be shifted to the previous or the next one continually. Thus, an electronic book or an album can be scrolled, the block of a picture can be moved, or a map or an amplified picture can be moved.

When the operation plate 20 is axially rotated (as showed in FIG. 3C), the instruction for rotating contents displayed by the electronic device 1 is executed, and the rotation direction of the contents is corresponding to that of the operation plate 20.

People with ordinary skill in the art can well understand that even if the movement reaches the limitation and the operation plate is unable to continue moving, the original instruction can still be executed due to the unreleased displacement until the displacement is released and the operation plate is returned to the original position, the original instruction stops executing. The mechanism may be achieved by setting in software or by the sensing module 40.

The operation plate 20 further includes a transmitting unit, which can transmit or exchange signals or information via a wired or wireless transmission mode.

If the transmitting unit transmits in a wired transmission mode, a transmission line 28 may extend downward from the lower surface of the operation plate 20 and is connected to the body 10 for transmitting the signals or information of the operation plate 20 to the electronic device. The transmitting unit also may transmit the signals or information of the operation plate 20 to the electronic device 1 via the Bluetooth or an infrared ray in the wireless transmission mode.

Taking the signal transmission an example, if the operation plate 20 is a touch pad, it transmits the pressing or moving signal to the electronic device 1 when it receives signals. Taking information transmission or exchange as an example, if the operation plate 20 is a touch panel or a handwriting pad, it transmits the handwriting information to the electronic device 1 when it receives the handwriting information.

The support module 30 may be an elastic element, such as a spring, which can back to it's original position after the external force is released, and it is not limited herein. The support module 30 also may be a connecting element in different types, such as a globular universal joint or other connecting devices without limitations of usage. In the embodiment, the support module 30 includes a plurality of springs, it would not limit the movement of the operation plate 20, and the operation plate 20 can move horizontally, vertically and rotate axially under the external force without limitations of usage. The operation plate 20 can return to the original position when the external force is released according to the character of the spring.

The sensing module 40 may be disposed at the body 10 or the operation plate 20, and the operating mode at the operation plate 20, such as the horizontal movement, the vertical movement, or the rotational movement, can be determined according to the sensing signal output by the sensing module 40, and then the instruction to be executed is determined. The placement of the sensing module 40 may be adjusted according to the operation mode to be sensed.

In this embodiment, the sensing module 40 includes a plurality of sensing elements, each of which may be a contact sensing element or a non-contact sensing element. The contact sensing element generates a signal when contacting with the object. The non-contact sensing element can sense the distance to the object and other physical characteristics according to the sensing principle of infrared ray or vibration wave and the like.

In this embodiment, a plurality of sensing elements are disposed at the surface of operation plate 20 and the body 10, respectively. When the operation plate 20 is pressed as shown in FIG. 3D, the sensing element 40a on the surface of the operation plate 20 contacts with the sensing element 40b on the surface of the body 10, and the sensing element transmits a moving signal to the electronic device, such as a clicking instruction of the right mouse button. Similarly, if the left side of the operation plate 20 is pressed, a click instruction like the left button of a mouse can be executed.

Furthermore, if the sensing elements 40a and 40b are disposed at the side of the operation plate 20 and the body 10, respectively, they can sense the relative distance and angle between the operation plate 20 and the body 10 to determine the movement mode of the operation plate 20 such as the vertical movement, the horizontal movement or the rotational movement. Then, the relating moving signal is transmitted to the electronic device 1 to determine the movement of the operation plate 20.

In addition, the electronic device 1 may further include a reposition module 50. The reposition module 50 may be disposed between the body 10 and the operation plate 20, and further to make the operation plate 20 return to the original position via the support module 30.

### The Second Embodiment

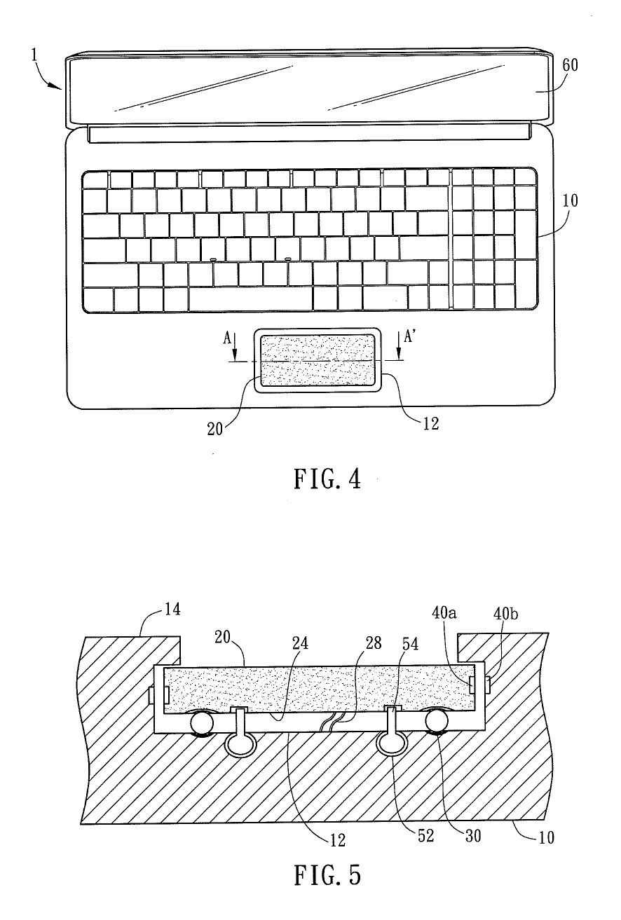

Please refer to FIG. 4 and FIG. 5. FIG. 4 is a schematic diagram showing the electronic device in the second embodiment. FIG. 5 is a cross-section diagram showing the electronic device in FIG. 4 viewed along a line A-A′.

Most features in this embodiment are the same as showed in the first embodiment. In this embodiment, a reposition module 50 (as shown in FIG. 2) includes a globular portion 52 embedded in the body 10 and an extension portion 54 (as shown in FIG. 5).

Moreover, to isolate the inner part of the electronic device from the outside, the body 10 in the embodiment may further include a protruding portion 14 to cover a gap between the body 10 and the operation plate 20. Covering the cap can provide protection for the body 10, and prevent external matters affecting the electronic device 1. If the operation plate is disposed in the opening of the body, a flexible film may be used to connect the operation plate and the body to avoid external matters or dust getting into the electronic device.

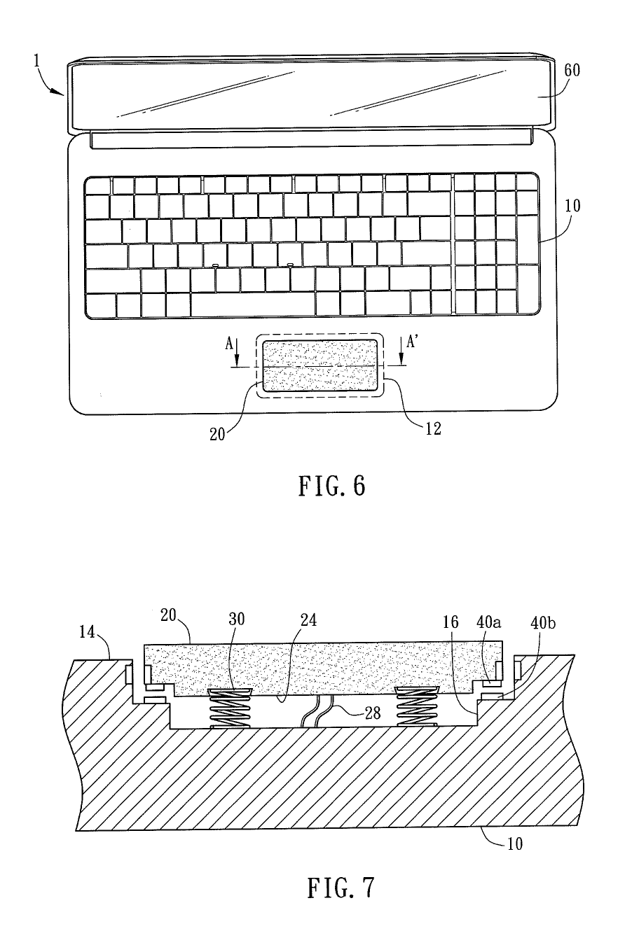

Moreover, in an embodiment, the body 10 further includes a ladder-typed structure 16. Please refer to FIG. 6 and FIG. 7. FIG. 6 is a schematic diagram showing another electronic device in the second embodiment. FIG. 7 is a cross-section diagram showing the electronic device in FIG. 6 viewed along a line A-A′.

The body 10 includes a ladder-typed structure 16, and the operation plate 20 includes a lower surface corresponding to the ladder-typed structure 16. The ladder-typed structure 16 is used for limiting the movement of the operation plate 20 and reducing the stroke of the operation plate 20 when the operation plate 20 is pressed, and thus the space requirement is low. Except the structure of the body 10, most features in this embodiment are the same as showed in the aforementioned embodiment.

### The Third Embodiment

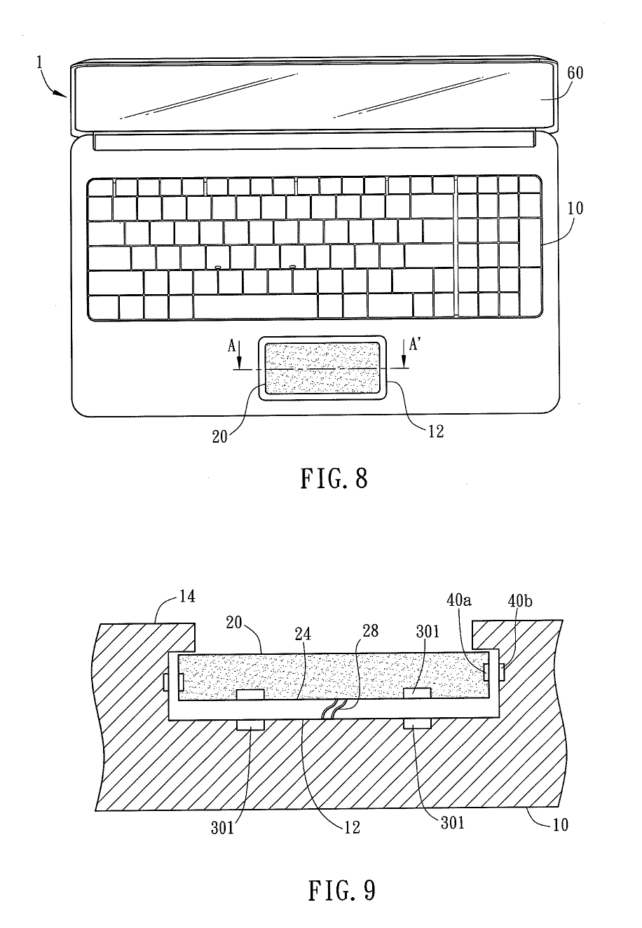

Please refer to FIG. 8 and FIG. 9. FIG. 8 is a schematic diagram showing the electronic device in the third embodiment. FIG. 9 is a cross-section diagram showing the electronic device in FIG. 8 viewed along a line A-A′.

Most features in this embodiment are the same as showed in the aforementioned embodiment. The main difference between this embodiment and the aforementioned embodiments is that the support module 30 is a magnetic connecting assembly 301. The magnetic connecting assembly 301 is disposed between the body 10 and the operation plate 20, respectively. The magnetic connecting assembly 301 provides a repulsive magnetic force to maintain a pressing stroke between the body 10 and the operation plate 20. Thus, after the force pressed on the operation plate 20 is removed, the operation plate 20 can return to the original position.

The magnetic connecting assembly 301 may be a permanent magnet or an electromagnet whose magnetism can be changed via a coil module.

The electronic device with the moveable operation plate provides a simple and intuitive operation interface. The user can intuitively control the operation plate by moving, rotating, and vertically pressing the operation plate to generate the intuitive operation instructions. Persons having ordinary skill in the art can understand that the operation plate can execute much more instructions via other motions except horizontal movement, vertical movement, and rotate movement as described above. The operation plate allows users to control the electronic device more intuitively. The relative application would not depart from the claimed scope.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An electronic device with a moveable operation plate, comprising:
a body;
an operation plate moveably disposed at the body and electrically connected with the body; and
a sensing module disposed at the body for sensing a movement of the operation plate to generate a moving signal,
wherein the moving signal is transmitted to the body to execute a corresponding instruction.

2. The electronic device according to claim 1, wherein a distance is formed between the operation plate and the body.

3. The electronic device according to claim 1, wherein the operation plate has a touch control function.

4. The electronic device according to claim 1, wherein an opening for disposing the operation plate is formed at the body.

5. The electronic device according to claim 1, wherein the body has a disposing portion for disposing the operation plate.

6. The electronic device according to claim 1, further comprising an elastic element disposed between the operation plate and the body.

7. The electronic device according to claim 1, further comprising a magnetic element disposed between the operation plate and the body.

8. The electronic device according to claim 1, wherein the movement comprises a vertical movement, a horizontal movement, a rotational movement, and an inclination movement.

9. The electronic device according to claim 1, wherein the corresponding instruction comprises a trigger instruction, a cursor moving instruction, a keying in instruction, a scrolling instruction, and a handwriting instruction.

10. The electronic device according to claim 1, further comprising a display coupled to the body.

11. The electronic device according to claim 1, wherein the sensing module is disposed at the operation plate for sensing the movement of the operation plate to generate the moving signal.

12. An operation plate module moveably disposed at a body of an electronic device, the operation plate module comprising:
an operation plate moveably disposed at the body and electrically connected with the body; and
a sensing module disposed at the body for sensing a movement of the operation plate to generate a moving signal,
wherein when the operation plate is disposed at the electronic device, the operation plate do not contact with the body, and the moving signal is transmitted to the body to execute a corresponding instruction.

13. The operation plate module according to claim 12, wherein the operation plate has a touch control function.

14. The operation plate module according to claim 12, wherein the movement comprises a vertical movement, a horizontal movement, a rotational movement, and an inclination movement.

15. The operation plate module according to claim 12, wherein the corresponding instruction comprises a trigger instruction, a cursor moving instruction, a keying in instruction, a scrolling instruction, and a handwriting instruction.
